(19) United States
(12) Patent Application Publication
(10) Pub. No.: US 2010/0104687 A1
(43) Pub. Date: Apr. 29, 2010

(54) SEGMENTED CONFECTIONERY PRODUCTS

(76) Inventor: Allan S. Kaplan, Boca Raton, FL (US)

Correspondence Address: ACCU-BREAK TECHNOLOGIES, INC., 1000 SOUTH PINE ISLAND ROAD, SUITE 230, PLANTATION, FL, 33324, US

(21) Appl. No.: 12/258,059

(22) Filed: Oct. 24, 2008

(51) Int. Cl. A23G 3/54; A23G 4/18

(52) U.S. Cl. 426/3; 426/76; 426/103; 426/512

(57) ABSTRACT

A confectionery article adapted for accurate division of a confectionery article into two or more smaller portions, which confectionery article has two or more segments having different compositions.

### FIELD OF THE INVENTION

The invention involves compressed confectionery articles of manufacture comprising two or more layers or segments. At least one layer or segment of the article comprises a flavor agent and the other layer(s) or segment(s) comprise a composition containing a flavor agent, an agent to enhance or complement the flavor agent, or an inert (e.g., unflavored) composition. More specifically, the subject invention concerns confectionery articles, such as a candy, and methods for providing said confections which are readily divisible and preferably comprise a deep score. The confectionery products of the subject invention can take various forms including hard and soft candies, chewing gum and pastilles.

### BACKGROUND

Layered comestible products containing one or more flavorants, sweeteners, or the like have been described. For example, U.S. Pat. No. 3,501,571 discloses a composition comprising a sugar such as amylase, dextrose, maltose, sucrose, or the like, which is used as an inert filler to form a layered antacid tablet. An antacid and simethicone are known to be provided in a candy-based lozenge, as described in U.S. Pat. No. 4,396,604.

U.S. Pat. No. 4,847,090 discloses a confection piece and a method for making the confection piece having two or more discrete parts, each part being different from another in respect of at least one of its physical and/or chemical properties. The two or more discrete parts can provide new and unique organoleptic responses for the user and particularly includes interactive components which should be kept separated until the confection piece is dissolved in the user's mouth.

U.S. Pat. No. 4,971,806 describes a multi-layered chewing gum composition. The composition has a moisture content of less than about 1% by weight of the composition and contains at least two layers each comprising a chewing gum composition. The chewing gum component can be formed as a candy confection product prepared by mixing a melted chewing gum base with a cooked hard candy sorbitol syrup at a temperature which renders the gum base and the cooked candy syrup miscible under mild blending conditions to form a substantially single phase continuous plastic chewing gum candy mass, then cooled to a hard candy matrix containing chewing gum. The candy-gum matrix is then suitable for scoring and cutting and for grinding into a particulate and/or a powder, as described in U.S. Pat. No. 4,741,905.

U.S. Pat. No. 6.060,078 describes a chewable tablet and a process for preparation of the tablet containing a medicament in a core and an outer layer wrapping the core which is made up of chewable base such as a gum, a soft candy or a caramel.

U.S. Pat. No. 6,231,900 describes a confectionery product, suitable for the relief of cough and cold-like symptoms, which includes a coolant composition and a flavor composition in separate, distinct and discrete regions. The coolant and flavor compositions are adapted to provide different release profiles.

European Patent Application No. EP-A-150,934 discloses a multi-layered chewing gum composition wherein the separate layers have different gum base content so that they release flavors at different rates.

European Patent Application No. EP-A-267,160 describes a shaped edible article of at least two discrete body parts joined together in a single compression step. One of the body parts differs from the other in at least one physical and/or chemical property and may be used for avoiding flavor-medicinal interactions such as antihistamines with aldehyde containing flavor components.

The inventors have also described several embodiments of layered pharmaceutical tablets containing an active pharmaceutical ingredient. These pharmaceutical products are disclosed in the following US patents: U.S. Pat. No. 7,329,418 and U.S. Pat. No. 7,318,935. Several pending applications concerning layered pharmaceutical tablets have also been published as: US2006/0003000, US2006/0165777, US2007/0014852, US2007/0134321, US2007/0142473, US2007/0207208, US200710237815, US2007/0287690, US2008/0003285, US2008/0064709, US2008/0075772, US2008/0199521, US2008/0213362, US2008/0233189, US2008/0233190, US2008/0241239, US2007/0244101, WO 2007/149860, WO 2008/021875, and WO 2008/067485. Each of these patents and published applications are incorporated by reference in their entireties.

None of the above patents or publications describe a layered, compressed candy or gum article having two layers and at least one deep score along a vertical axis of the article, or a compressed candy or gum article having three or more layers or segments providing at least one middle layer or segment as a breaking segment to be broken through, thereby providing at least one unbroken or intact layer or segment in each of the resulting broken portions. Nor do any of the patents or applications discussed above provide a compressed candy or gum article having three or more layers or segments wherein the article is configured to have its height greater than its width (H>W) as positioned in a tablet press, or having a score formed in the side of the H>W article or a deep score along a vertical axis of the article.

These heretofore undescribed features are advantageously provided by an article of the subject invention, embodiments of which are described in detail herein.

### SUMMARY OF THE INVENTION

The subject invention relates, generally, to a candy or gum product which is advantageously adapted for easily dividing the product, by breaking the product, through a deep score or, in certain embodiments, for easily dividing one segment from another by breaking or even biting through a breaking segment, while keeping intact certain other segments containing flavorants, flavor enhancers, colorants, or the like.

The unique configurations for a candy or gum product of the subject invention provide several advantages, which include, but are not limited to: the capability to combine a candy composition in one layer and a chewing or bubble gum composition in another layer wherein the candy and gum compositions are readily separable from one another, e.g., by dividing the article through a separation layer. Similarly, the subject invention can provide different flavorings or colorants in the separate, and separable, layers or segments to provide a single confectionery product having more than one flavorant in discrete layers or segments of the article.

In addition, the differing compositions for each of the layers or segments can provide different release rates for each of the compositions, e.g., a fast-release or immediate-release composition for one or more of the layers or segments and a controlled-release composition in other layers or segments.

These advantageous configurations further provide a user of the product with the ability to take a whole, undivided product containing, for example, two different flavors, or to separate the two different flavors by breaking the article and taking a divided portion of the product containing a single flavor. Similarly, a product of the subject invention containing a combination of a candy composition and a chewing gum or bubble gum composition allows the user the ability to take whole said candy and gum combination or to separate them from each other before ingesting either or both divided portions. Alternatively, the flavorants can be the same or different, but have different release rates from each of the layers or segments.

In certain embodiments having at least one deep score, the score pattern forms ridges in the product which can provide a novel and desirable or pleasing mouth feel or other organoleptic property.

The present invention concerns configuring candy or gum formulations, e.g., granulations comprising at least one flavorant, in different parts or segments of a compressed article, which can be in the shape of a tablet. For convenience of reference, the articles of the subject invention, though capable of taking a variety of shapes and sizes, are commonly referred to herein as compressed “articles,” or “confectionery articles,” but may also be referred to as “tablets.” The articles are typically compressed using a tablet die in a tablet press, as is well understood in the art of compression manufacturing of pharmaceuticals, foodstuffs, or the like.

Preferably, a compressed article of the subject invention has at least one layer or segment which serves as a “breaking layer” or “breaking segment” and thereby allows the article to be broken, through that breaking segment, advantageously allowing the layers or segments to be separated from one another, into separate portions, but allowing certain layers or segments to remain intact. This property can be especially advantageous when breaking of a controlled-release segment may disrupt or destroy the controlled-release capability of that layer or segment. In a preferred embodiment, the separating layer or segment is of dimension (e.g., height, as defined or referred to herein) adequate to allow breakage transversely through the breaking layer without consequent breakage of other layers or segments.

The subject invention comprises two basic embodiments. The first of these embodiments is an article having two layers (a bi-layer confectionery article) and a deep score formed substantially completely through at least one of the layers. The deep score allows a substantially complete division of the layer in which the deep score is formed, thereby resulting in two separate segments in that single layer. Thus, a bi-layer article having one deep score results in three segments—a single, unscored layer/segment, and two segments which are formed by the scored layer. It would be understood that additional deep scores in a layer will form additional segments within that layer.

More specifically, a bi-layer embodiment of an article according to the subject invention comprises:
(a) a first confectionery composition forming a bottom layer as the article is oriented during manufacture, said first composition comprising a confectionery ingredient or a mixture of confectionery ingredients, said composition being free of active pharmaceutical ingredient;
(b) a second confectionery composition forming a top layer as the article is oriented during manufacture, said composition comprising a confectionery ingredient or a mixture of confectionery ingredients, said second composition being free of active pharmaceutical ingredient; and
(c) said first and second confectionary compositions forming a bi-layer confectionery article having at least one deep score in the top or bottom layer.

Another embodiment of the subject invention concerns a compressed article having three or more layers (a tri- or multi-layer article) formed from at least two different compression compositions. In this embodiment, the compositions are layered such that there is at least one middle, or interposed, segment having a different composition than either of the compositions forming the segments abutting the middle or interposed segment.

These configurations are referred to using designations for a first flavored segment (A), an inert or unflavored segment (I), and a second flavored segment (B). Thus a tri-layer article having the same flavored segment at each end, and having an unflavored segment disposed between those same-flavored segments can be referred to as an A-I-A configuration. Where one of the flavored end segments is different than the other, the configuration can be referred to as an A-I-B configuration. Articles having more than three segments include A-I-A-I, A-I-B-I, A-B-I-B-A, and the like.

Other designations for the segmented articles would be readily understood. For example, an article having more than two flavored segments would be understood as an A-I-B-I-C configuration where each of three flavored segments are separated by in interposed unflavored segment.

In addition, a tri- or multi-layer article of the subject invention is advantageously formed to have its height greater than its width. The height is the vertical dimension of the article as it is compressed in a die. The middle layer or layers of the tri- or multilayer embodiment can serve as the breaking layer. This breaking layer can be advantageously broken through without breaking through either of the layers or segments abutting the middle layer. This embodiment can optionally include a score in the “side” of the article, either transverse to, or along the vertical height of the article, or can have a score or deep score formed in an end layer.

More specifically, a three-layer embodiment of a confectionery article according to the subject invention comprises:
(a) a first layer comprising a first confectionery composition forming an end segment, as oriented during manufacture, said first composition comprising a confectionery ingredient or a mixture of confectionery ingredients and being free of active pharmaceutical ingredient;
(b) a second layer comprising a second confectionery composition forming a middle segment, as oriented during manufacture, said composition comprising a confectionery ingredient or a mixture of confectionery ingredients different than said first composition and being free of active pharmaceutical ingredient; and
(c) a third layer forming an end segment, said third layer comprising said first confectionery composition, or a third confectionery composition comprising a confectionery ingredient or mixture of confectionery ingredients different than said first or second compositions, said third composition being free of active pharmaceutical ingredient.

Preferably, the tri-layer article described above is configured to have its height greater than its width as oriented in a die, during its manufacture.

The embodiments of an article of the invention can be compressed in a compression die using top and bottom punches, wherein at least one of said top or bottom punches comprises an embossing of sufficient height to form a deep score in the respective top or bottom layer. Alternatively, the confectionery article can be formed in a mold.

Preferably, the confectionery article of the invention comprises at least one composition comprising a flavoring ingredient, a flavoring enhancer, or the like as are commonly used in confectionery articles such as candies or gums. These compositions can be formulated as a rapidly dissolving composition, or as a slowly dissolving composition, which can provide extended-release characteristics to the flavoring ingredient or other ingredients contained in the composition.

The subject invention further concerns a method for manufacturing a compressed bi-layered and deep-scored confectionery article, or a tri- or multi-layered article of the subject invention. For example, a method for manufacturing a bi-layered, deep-scored article of the invention can comprise the steps of:

providing a compression die having a top and bottom punch for use with a bi-layer tablet press, wherein at least one of said top or bottom punches comprises one or more embossing for forming one or more deep scores in the respective top or bottom layer of the confectionery article when compressed;

providing a first confectionery composition comprising a confectionery ingredient or a mixture of confectionery ingredients and being free of active pharmaceutical ingredient;

providing a second confectionery composition comprising a confectionery ingredient or a mixture of confectionery ingredients and being free of active pharmaceutical ingredient,

dispensing said first confectionery composition into the compression die to form a first layer;

optionally, tamping said first layer;

dispensing said second confectionery composition into the compression die and onto said first layer, thereby forming a second layer;

optionally tamping said second layer; and

compressing said first and second layers to form the bi-layer confectionery article having at least one deep score.

The method described above can be carried out using a bottom punch comprising an embossing dimensioned to have a height such that the embossing extends completely through the compressed bottom layer and thereby creates unitary segments in that bottom layer. Alternatively, the method can be carried out using a top punch having an embossing which extends a distance substantially equal to or greater than the thickness or height of the top layer of the confectionery article, thereby forming a deep score in said top layer.

It follows that a method for manufacturing a tri- or multi-layered confectionery article of the invention configured to have its height greater than its width as oriented in a compression die can include the steps:

providing a compression die having a top and bottom tablet punch for use with a tablet press capable of forming a compressed article having three or more layers;

providing a first confectionery composition comprising a confectionery ingredient or mixture of confectionery ingredients and being free of active pharmaceutical ingredient;

providing a second confectionery composition comprising a confectionery ingredient or mixture of confectionery ingredients and being free of active pharmaceutical ingredient;

optionally, providing a third confectionery composition comprising a confectionery ingredient or mixture of confectionery ingredients and being free of active pharmaceutical ingredient;

dispensing into the compression die the first composition to form a first layer;

optionally, tamping said first layer;

dispensing into the compression die and onto the first layer said second composition, thereby forming a second layer;

optionally tamping said second layer;

dispensing into the tablet die and onto the second layer said first or third confectionery composition, thereby forming a third layer;

optionally, tamping said third layer; and

compressing said first, second and third layers to form the layered article.

Use of a die having an embossing to form a deep score in a top or bottom end segment can also be used in a tri-layer article. In addition, a confectionery article having four or more layers can be provided by the above methods, wherein the method comprises the further steps of, for example, forming a fourth layer comprising a confectionery composition different than the composition forming the third layer, or forming a fifth layer comprising a confectionery composition different than the composition forming the fourth layer, and so on.

The subject invention further includes confectionery articles formed by the methods as described above, and comprise at least two compositionally different segments.

### BRIEF DESCRIPTION OF THE DRAWINGS

FIG. 1A is a cross-section of a taller-than-wide confectionery article looking towards the side of the confectionery article that has a score;

FIG. 1B is a cross-section of the confectionery article of FIG. 1a looking at the side of the confectionery article where the score ends;

FIGS. 2A-2B and 2C-2D are views of FIG. 1A and FIG. 1B respectively when the confectionery articles have been broken through the score.

FIG. 3 is a cross-section of a taller than wide confectionery article having two segments, one of which is about three-quarters of the height of the confectionery article.

FIGS. 4A-4B are views of FIG. 3 when the confectionery article has been broken transversely.

FIG. 5 is a cross-section of a taller than wide confectionery article having five segments.

FIGS. 6A-6B are views of FIG. 5 when the confectionery article has been broken through one segment.

FIGS. 7A-7C are views of FIG. 5 when the confectionery article has effectively been broken through two segments in two steps, first by breaking the confectionery article and then by breaking the tablette of FIG. 6B.

FIG. 8 is a cross-section of a confectionery article that has three segments.

FIG. 9 is an external perspective view of a scored confectionery article that has three segments.

FIG. 10 is an external en face view of a confectionery article that has three segments and that has a band around the width of the middle (inner) segment of the confectionery article that extends to the sides.

FIG. 11 is an external en face view of a confectionery article that has three segments into which perforations have been created in the middle segment.

FIG. 12 is an external view of a confectionery article with three segments on the middle segment of which are two horizontal (transverse) dotted lines close together.

FIG. 13 is a cross-section of a wider than tall confectionery article with two segments one of which is deeply scored.

FIGS. 14A and 14B are views of FIG. 12 when the confectionery article has been broken at an angle from vertical.

FIG. 15 is a cross-section of a confectionery article with two segments one of which is substantially inactive.

FIG. 16 is a cross-sectional view of a three segment confectionery article, two segments of which are unitary segments.

FIGS. 17A and 17B depict two tablettes formed by splitting the confectionery article of FIG. 16 through the top of the score.

FIG. 18 is a cross-section view of a confectionery article with three segments, two of which are unitary segments.

FIG. 19A is a external perspective view of a three segment confectionery article with two unitary segments.

FIG. 19B is an en face external view of the same confectionery article shown in FIG. 19B.

FIG. 20 shows a confectionery article with four segments, two of which are unitary segments.

FIGS. 21A and 21B are cross-sections of each tablette formed by breaking the confectionery article of FIG. 20 through the middle segment.

FIGS. 22A and 22B demonstrate the tablettes formed by breaking the tablette of FIG. 22B as guided by the score.

FIG. 23 illustrates a process employed in the manufacture of gummy candy.

### DETAILED DESCRIPTION OF THE INVENTION

All of the whole confectionery articles described and shown herein can comprise at least one segment that intrinsically has an altered-release characteristic. Intrinsic altered release characteristic refers to the release property of the composition itself, i.e., altered or controlled release (as compared to immediate release) of flavoring agents or the like from the composition. The confectionery articles of the invention can further employ a device or composition, such as a coating or membrane or the like, that is extrinsic to the segment composition for altering or controlling said release.

In accordance with the subject invention, the terms “altered release” and “controlled release” are contemplated to include an article or form or composition that has the property of releasing active ingredient from the article at a modified or “altered” rate relative to the rate of release of a flavorant or the like from a conventional “immediate release” formulation, as would be well understood in the art. Therefore, the term “altered release” includes “controlled release”, “delayed release”, “extended release”, “long-acting”, “modified release”, “slow release”, “sustained release”, “time release”, and the like, all of which are understood to refer to a release which is later or slower than “immediate release.”

However, “altered release” may also mean a release rate which is more rapid than a conventional immediate release confectionery article, for example, a rapid-dissolve confectionery article or quick-dissolve confectionery article, which dissolves in the mouth or buccal area before being swallowed, as is also well known and understood in the industry. A release which is delayed due formulation with enteric or other materials, though releasing immediately following the delay, is understood in the art to be a type of “controlled release”, and is so considered for purposes of the subject invention. “Slow release,” “extended release,” “long-acting,” “sustained release,” “time release,” and the like, are generally recognized as being synonymous and may be used interchangeably herein to designate an “altered release” or “controlled release” formulation which is not “delayed release.” The term “intrinsically altered release” refers to a controlled release property of a composition, e.g., a granulation, whereby the release rate of a flavorant or other such ingredient used in candies or gum from that composition is affected by the ingredients or excipients of that composition and not a device or composition that is extrinsic to that composition, e.g., a coating or membrane disposed onto or formed around the composition.

One preferred embodiment of the invention is a confectionery article having two or more segments, a top and a bottom, and has a height that exceeds its width, i.e., the confectionery article is taller than it is wide. The “height” or “thickness” as referred to herein, is measured vertically from the top to the bottom of said confectionery article as the article is oriented in the compression die. The “width” of the article is measured as the greatest horizontal dimension of the article at a location halfway between the top and bottom of the article, except that when the horizontal cross-section of the article is substantially rectangular, the width is defined by locating the two shorter sides of the perimeter of the horizontal cross-section, and measuring the length of a line that is at right angle to said shorter sides. The terms “vertical” and “horizontal” (“horizontal” is also referred to as “transverse”) axes of the confectionery articles of the invention are determined by, and have the same orientation as, that of the compression die in which the confectionery article is compressed in a press, such as a tablet press or other tabletting machine (“tablet press” herein), and the order of entry of granulations or other formulations into the die.

Taller-than-wide confectionery articles of the invention are shaped to be more easily broken through their vertical axes (i.e., in a horizontal direction) than are conventional, currently-manufactured articles having a “wider than tall” configuration. A preferred use of confectionery articles of the invention is to break through an interposed segment of the confectionery article wherein the interposed segment is lacking a flavorant, e.g., splitting the article into two or more pieces without breaking through a segment that may contain a flavorant, flavor enhancer, or other ingredient as desired for a candy product, that is positioned above or below said interposed segment. This is especially useful if the composition containing a flavorant is formulated as a controlled-release composition, the properties of which may be disrupted or destroyed if broken.

In another preferred embodiment, the subject invention concerns a controlled release compressed confectionery article that has two or more segments, wherein a first segment includes a flavorant and has a deep score that extends more than about 75% into said first segment. More preferably, in one embodiment the score can be formed from about 90% to 100% of the height or thickness of said first segment. In an alternative embodiment, the score is formed completely through the first segment and can extend into the second, adjoining segment.

Confectionery articles of the invention are adapted to be useful not only as whole confectionery articles but also to be breakable into subunits known herein as “tablettes.” An example of tablette formation is as follows: a standard single-scored, mono-layer, homogeneous confectionery article is broken. Said breaking produces two major fragments, each of which is called a tablette. Some chipping and crumbling, which are preferably minor in amount, may occur. The two major fragments of the confectionery article are “tablettes” and the term does not include the smaller fragments such as crumbs or chips.

It is one object of the invention to create controlled release confectionery articles adapted to be broken when it is desired to divide one flavor segment from another by breaking through a breaking segment, preferably, without breaking any flavor segment—only braking the breaking segment.

Confectionery articles of the invention are preferably produced on a layer press, such as a bi-layer press, or a tri-layer or five-layer high speed tablet press manufactured by Korsch AG of Germany. Remington's Pharmaceutical Sciences 20th Ed., Mack Publishing Co., Easton, Pa. (2000), Chapter 45, which is incorporated by reference, describes the various techniques utilized in making compressed tablet. The confectionery articles of the invention are primarily intended for oral ingestion but they may also be used for other applications. Except for use within a formulation of an excipient having inherent adhesive properties, confectionery articles of the invention are not formed using a cement, glue, adhesive, or the like, and are preferably uncoated.

The confectionery articles are formed by compressing at least two different formulation compositions, e.g., granulations, so they are configured as separate layers or segments in the final compressed article. Embodiments of the subject invention include, but are not limited to, a vertically compressed confectionery article having a height greater than its width (a “taller than wide” confectionery article), and a unitary segmented confectionery article. These embodiments can comprise a separation mark or score.

A layer is produced by introducing an amount of an individual granulation into a tablet die to fill at least a part of the die. A layer is considered to be present whether it is the form of an un-tamped, tamped or fully compressed granulation. In addition, multiple layers of an identical or substantially identical composition are considered to be part of the same “layer.”

As an example of a method of manufacture of a preferred confectionery article of the invention, first, a granulation containing a flavorant or the like enters the die and is tamped to form a first segment. Second, a granulation lacking a flavorant (an “inert” granulation) enters the die and is tamped. The inert granulation creates a part of the confectionery article that can be identified and broken through as the breaking layer or segment. Last, a second granulation containing a flavorant or the like (the same or different than the first composition) enters the die, and is optionally tamped. Then, a final compression to form a third segment and the final compressed product occurs. After final compression, said confectionery article is ejected from the die. While one or all segments may individually have a width greater than height, the confectionery article as a whole has a height that exceeds its width.

Examples of suitable dimensions for confectionery articles according to the invention are: height: 6 to 24 mm; preferably 10 to 18 mm and more preferably from 10 to 14 mm; width (at the widest dimension of the horizontal axis): 2 to 16 mm; preferably 3 to 10 mm and more preferably 4 to 8 mm. Without limitation, the dimensions of the confectionery article may be optimal if the ratio of the height to the width is between about 1.5:1 to about 3:1.

Subsequent to formation of the final (whole) confectionery article, a score may optionally be placed in the side of said confectionery article, preferably transversely. Alternatively, after confectionery article formation, a printed line or other forms of indicia such as dotted lines, symbols or perforations may be placed on or in the surface of the confectionery article, all of which serve the purpose of allowing identification of said confectionery article's desired breaking region. Other means of aiding identification of a breaking region may be utilized such as the use of contrasting colors in different segments.

Different granulations may be of the same or different colors. Wet granulations are often preferred to limit transfer of material from one feed frame on the tablet press. Direct compression of powder can also be a manufacturing technique used in the subject method.

By convention herein, the term “segments” may be used in place of “layers” in general in discussing the finished confectionery articles of the invention, for reasons that are explained below. In addition, for convenience of reference and consistency throughout this specification, the descriptions herein may refer to the segments as comprising or utilizing a particular “granulation”. Such term is not limited to the formation of granules, per se, as in a wet granulation process. Other formulation compositions, for example, homogeneous mixtures or blends used in direct compression matrix formulations, coated or uncoated beads or pellets used in compressed confectionery articles, or like compositions as are well known in the art and suitable for use in conventional layered, compressed confectionery article technologies, can be readily substituted for such “granulations” and are considered within the scope of the invention. It is expressly intended that the subject invention include each of these alternatively available and well known compressible formulation technologies.

A segment represents the entirety of a substantially homogeneous contiguous part of a confectionery article. A segment may be formed from more than one layer, however. If two substantially identical granulations entered the tablet die successively, with the second entering directly after and onto the first, such as at two successive filling stations during automated high-speed tablet manufacture, then the two granulations would each form a separate layer after entering, but when compressed, they would comprise one segment. Although it follows that two separate compositions containing two different flavorants or the like, form two segments, a composition comprising the same flavorant but with dissimilar excipients is a different composition and therefore would also form two segments even if compressed onto another.

A segment formed by a plurality of layers that are formed from substantially identical granulations is called a compound segment. Compound segments may prove useful in situations of relatively large quantities of a granulation requiring two or more consecutive fills (“feeds”). A layer formed from a granulation that is neither disposed upon nor under (i.e., does not adjoin and is not contiguous with) a substantially identical granulation is a simple segment. A non-compound segment is a simple segment.

As used herein, such terms as “horizontal” (“transverse”) and “vertical” when used in relation to a confectionery article, are based on the spatial orientation of the confectionery article as, and after, it is produced in a die, but before removal or ejection from the die. Current methods of manufacture produce confectionery articles with one granulation entering the die on top of another, so that confectionery articles of the invention produced in such a manner comprise one or more top (outer) segments, one or more bottom (outer) segments, and optionally one or more middle (inner or interposed) segments. A segment that is not a top or bottom (i.e., outer) segment is considered to be an inner segment.

In any configuration of a confectionery article according to the subject invention, the lateral facets of any outer (top or bottom) or inner (middle) segment typically have an externally exposed surface. These exposed surfaces, however, can then be coated or encapsulated.

Confectionery articles of the invention are preferably uncoated, but can be coated with conventional coatings for aesthetic or functional or other purpose. However, these coatings are not regarded as a “layer” or “segment” of the confectionery articles of the subject invention.

The term “inert segment” refers to a segment that is substantially free of a flavorant, colorant, flavor enhancer, or the like, but may contain compressible sugars or other fillers although these ingredients may technically be considered as “sweeteners.” Alternatively, the “inert” segment can include a segment which contains a flavorant, but which does not include ingredients which can affect the release profile of the flavorant contained in that segment or another segment.

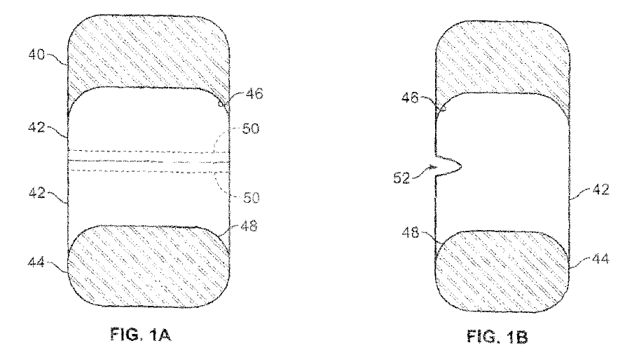

If separate granulations were to be sequentially placed in a die horizontally (side-to-side) and not vertically as is currently the practice, then the confectionery articles so produced would be within the scope of the present invention because the same resultant product would be produced by the horizontal compression process When the confectionery article of FIGS. 1A and 1B, for example, lies on a flat table, it will tend to lie lengthwise at right angles to the manner in which it is formed in the die, so that if the three segments were all different colors, then the segments would appear to be arranged horizontally (side-to-side) rather than vertically (one on top of the other). For consistency of terminology, such segments nonetheless are considered to be disposed vertically.

The confectionery articles of the invention are preferably broken transversely in order to realize their benefits or advantages. They may be broken in standard ways, according to the invention such as either by applying force manually (or “by hand” as the term is commonly understood) to cause the confectionery article to break at a desired location, or by use of an instrument, such as a cutting edge, to apply force directly to a separation mark provided in a desired breaking region.

Separation marks are intended to guide optional breaking in the usual manner that is well known with scores, so that, if breaking is desired, force can be applied to break the confectionery article at or about the separation mark in a direction that is substantially perpendicular to the surface on which it is desired. The confectionery article according to the invention may be broken either by applying force manually or by an instrument such as a cutting edge directly to the separation mark, or to other areas of the confectionery article, such as the outer segments, to cause the confectionery article to break at or about the separation mark and in the direction of the separation mark.

The separation mark or marks may comprise one or more of the following:

(a) a score in a side wherein said score is not oriented vertically;

(b) indicia on at least one side or lateral face of the confectionery article that indicates or locates a desired breaking region of said confectionery article;

(c) a band which is located on one segment or at an interface of two segments; or

(d) an inner segment or interposed segment that has a different color from the end segments.

Examples of specific embodiments of the invention are best described with reference to the drawings. The drawings depict vertical cross-sectional views of confectionery articles and tablettes of the invention. Confectionery articles are depicted as if they were in the compression die, so that the top of the confectionery article as it is oriented on the page corresponds with the top of the confectionery article in the die. In other words, the top segment of the confectionery article as viewed contains the last granulation to enter the die. Tablettes are depicted as they would have been in the die before they were separated from the intact confectionery article. Shaded or cross-hatched areas represent segments derived from granulations which contain a flavorant or the like; clear (plain) areas represent segments derived from inert granulations, i.e., those formulated with no flavorant or the like.

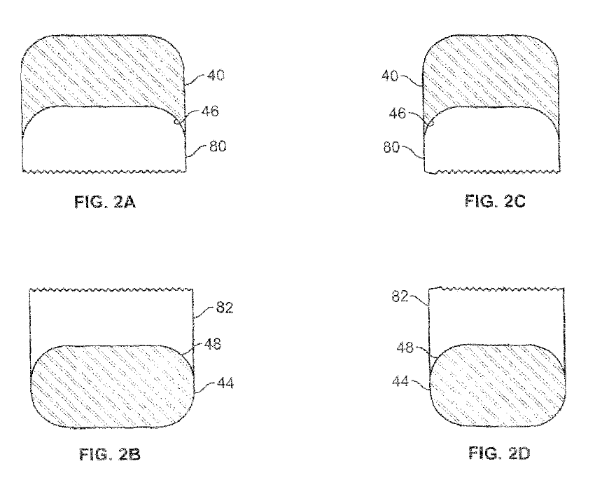

“Front views” refer to a cross-sectional view of a confectionery article that has a theoretical geometric plane passed through the confectionery article relative to a side which is arbitrarily designated as the front. Figures labeled as “side view”, which also have a corresponding “front view”, are taken as a cross-section through the whole confectionery article from the right side of a front view i.e. a side view is a cross-section that is taken by passing a plane through the vertical axis of the whole confectionery article at a 90° angle to the cross-sectional front view. Each front view represents a schematic cross-section that passes through the midpoint of the horizontal cross-section as measured from the front of the confectionery article to the back of the confectionery article or tablette. The front view is also parallel to the major axis of the confectionery article (e.g, for a confectionery article with a rectangular (but not square) transverse cross-section, the longer side of the perimeter is parallel with the plane that depicts the cross-sectional, front view). That plane is located half-way between the front and back surfaces of said confectionery article. The side views of FIGS. 1b and 2c-d are taken from a vertically-oriented plane that passes through the midpoint of the longer transverse dimension (i.e., the width), and thus are located at and perpendicular to the mid-point of the front view. Drawings are of confectionery articles that have a rectangular but not square horizontal cross-section at the vertical mid-point of the confectionery article.

Dotted lines in the confectionery articles depicted in the figures may represent printed marks or other indicia, or scores that are present on or in the surface of the confectionery article and, if they represent a score, said score does not extend deeply enough into the confectionery article to appear in the cross-sectional front view. The transverse dotted lines reflecting scores shown in the Figures imply no intention to limit the depth of any scores of the confectionery articles of the invention. Horizontal dotted lines on the front views that represent the surface scores are schematic, and do not necessarily represent the full vertical extent of a score, printed mark, or the like.

Tablettes are depicted with broken surfaces as indicated by a saw-tooth pattern. Such saw-tooth depiction is schematic and not intended to represent the actual pattern of breaking of a confectionery article (or tablette), which often leads to irregular edges even if said confectionery article is broken through a score.

Separation marks in the confectionery articles depicted in the Figures are depicted as scores that are present on or in the surface of the confectionery article and that do not extend deeply enough into the confectionery article to appear in the cross-sectional front views are depicted in the drawings as dotted lines to reflect the location of said scores on or in the surface of the confectionery article (not shown). It is to be understood that the depth of a separation mark or other score may be deeper than one-half the widest cross-section of the confectionery article in a particular embodiment, and thus the transverse dotted lines reflecting scores that are separation marks shown in the Figures imply no intention to limit the depth of any scores of the confectionery articles of the invention. Similarly, the confectionery articles shown that contain scores do not limit the width or extent of said scores.

The horizontal dotted lines on the front views that represent the surface scores are schematic, and do not necessarily represent the full vertical extent of the score. (Perforations or discontinuous scores through the width or depth of the confectionery articles are not depicted herein, but remain within the scope of the invention, as are other marks on or physical changes to the confectionery article that create a separation mark.) Any scores or printed indicia that serve as separation marks are for convenience herein assumed to be on the front surface of the confectionery article, which is arbitrarily chosen from a vertically-oriented surface of the confectionery articles. The “side view” of a confectionery article is a cross-sectional view of the confectionery article rotated 90 degrees from the front view, and is shown in FIGS. 2C and 2D. No dimension of the separation marks is limited by their depiction as dotted lines in any figure.

FIGS. 1A and 1B depict a confectionery article with compositionally substantially identical upper segment 40 and lower segment 44. In a preferred embodiment, a controlled-release formulation is present in each segment 40 and 44. Inner segment 42 may contain trace amounts of the flavorant or the like present in each of segments 40 and 44; in a preferred embodiment said flavorant or the like comprises coated particles. Interfaces 46 and 48 represent regions in which the upper part of segment 42 and the lower part of segment 42 respectively adjoin upper segment 40 and lower segment 44. The curved interfaces result from the profile of the upper tablet punch which is curved. Score 52 is depicted in FIG. 1B. Dotted line 50 in FIG. 1A is a reflection of score 52 on the surface of the confectionery article (not shown), that does not penetrate half-way through the shorter transverse axis of the confectionery article.

FIGS. 2A-2D depict tablettes formed by breaking the confectionery article of FIGS. 1A and 1B through score 52. Inner segment 42 of FIG. 1A no longer exists as an intact segment. The upper tablette of FIGS. 2A and 2C contains segment 80 that adjoins intact upper segment 40 and the lower tablette of FIGS. 2B and 2D contains segment 82 and intact segment 44.

Breaking the confectionery article of FIGS. 1A and 1B through the score placed in segment 42 is clearly easier than breaking the confectionery article through its vertical dimension. The fact that during preferred means of breaking said confectionery article, no break is made in the parts of the confectionery article where the flavorant or the like has been placed provides for exceptionally accurate breaking relative to the flavorant contained in the confectionery article.

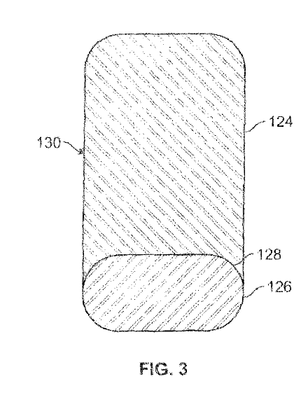

FIG. 3 demonstrates a two-segment confectionery article, each segment formed from a granulation containing a flavorant or the like. In a preferred embodiment, coated particles that create a controlled release of said flavorant comprise upper segment 124 and an immediate release granulation containing flavorant comprises lower segment 126. Upper (outer) segment 124 is larger than lower (outer) segment 126. Interface 128 indicates a region (interface) at which said segments are contiguous. A printed mark on the outer surface of the confectionery article (not shown) indicates a potential breaking point, as indicated by the location of arrow 130 that reflects the position of said surface printed mark. The two segments 124 and 126 also can have different colors, further allowing identification of which part of the confectionery article contains which segment.

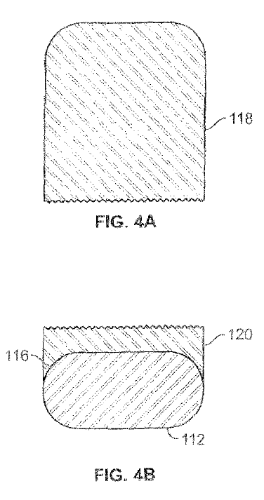

FIGS. 4A and 4B depict two tablettes formed by breaking the confectionery article of FIG. 3 through a print mark positioned as indicated by arrow 130. The tablette of FIG. 4A consists of segment 118, which represents the bulk of segment 124 of FIG. 3. The tablette depicted in FIG. 4B contains segment 112 in an intact form and segment 120, which represents a less than half-portion of segment 124 of FIG. 3. Interface 116 indicates a region at which said segments are contiguous. The curvature of interface 116 is due to the profile of the upper tablet punch.

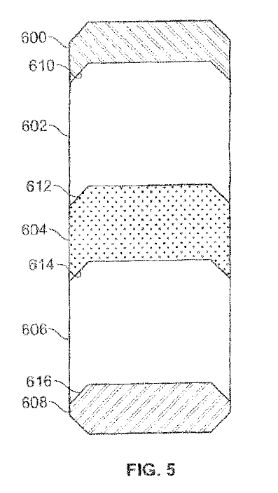

FIG. 5 illustrates a confectionery article more elongated than those previously demonstrated. This elongation can facilitate breaking through one segment. Upper segment 600 is provided with a quantity of flavorant or the like; stippled inner segment 604 is provided with a quantity of a different flavorant or the like; and, lower segment 608 is provided with a quantity of a flavorant or the like different from that found in a segments 600 and 604. Clear (plain) inner segments 602 and 606 contain an inert composition. Interfaces 610, 612, 614, and 616 represent the regions at which two contiguous segments adjoin. The confectionery article of FIG. 5 can be provided with a different color for each segment, as shown, though no requirement for this color differentiation by segment exists for confectionery articles of the invention.

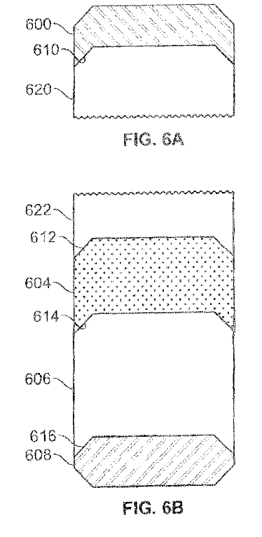

Even though there is no surface scoring or indicia, the color scheme is such that a person's attention may be directed to apply force to break the confectionery article through segment 602 to create the tablettes depicted in FIGS. 6A and 6B. FIG. 6A depicts the smaller tablette created by breaking the confectionery article of FIG. 5 through segment 602 in a transverse fashion. Segment 620 has been created by said breaking, and segment 602 of FIG. 5 no longer exists as an intact segment. FIG. 6B depicts the larger tablette created by said breaking of the confectionery article of FIG. 5. New upper segment 622 has been created.

Segment 608 of the confectionery article of FIG. 5 comprises an altered-release composition chosen from those well known in the art. No limitation of the ratios of the five segments of said confectionery article relative to the dimensions of the whole confectionery article exists.

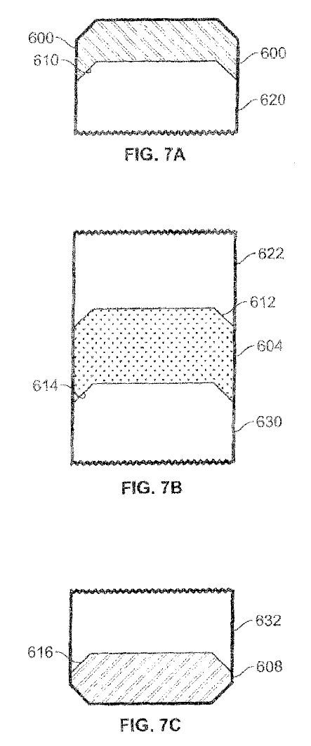

FIGS. 7A-7C depict three tablettes created by the subsequent breaking of the tablette of FIG. 6B. New segment 630 and segment 632 have been created and segment 606 no longer exists as an intact segment. Assuming minimal to no intermixing between the materials forming each segment of the confectionery article of FIG. 5 and assuming that segment 632 of FIG. 7C is substantially free of any flavorant or the like, the tablette of FIG. 7C represents a novel altered release article, in part in that it consists of an altered release product adjoining in a segment an immediate release substantially inactive segment.

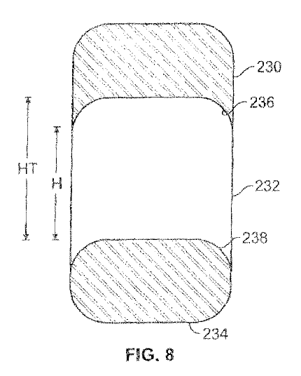

FIG. 8 shows a cross-section of a confectionery article comprising three segments.

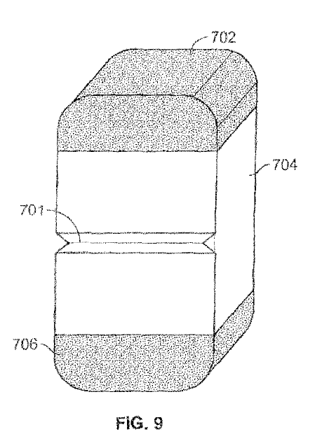

FIG. 9 is a perspective view of a confectionery article of the invention which shows score 701 as a separating mark on a front surface and top active (a flavorant or the like-containing) segment 702; middle inert segment 704 (no substantial amount of a flavorant or the like) and bottom active segment 706. When the confectionery article is broken through the score 701, the top segment and the bottom segment will remain intact. Segments 702 and 706 each contain a compositionally identical formulation.

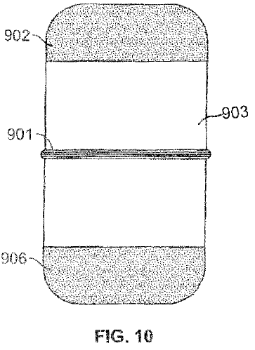

FIG. 10 is a front view of a confectionery article of the invention showing a gelatin band 901. Techniques such as those used to band capsules, as disclosed in U.S. Pat. No. 4,922,682, which is incorporated by reference, may be modified to provide a band in making confectionery articles according to the invention. Segments 902 and 906 are compositionally distinct and contain different volumes of material. Lower segment 906 comprises a matrix formulation; upper segment 902 comprises an immediate-release composition. Middle (inner) segment 903 contains an inert composition.

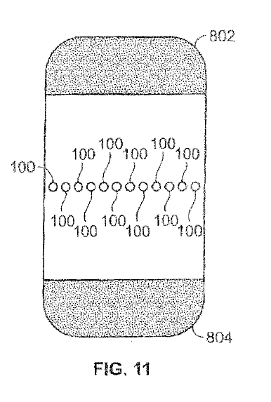

FIG. 11 shows a series of perforations 100 that may be made in the surface of a confectionery article to form a separation mark according to the invention. These perforations may be formed e.g. by mechanical or laser drilling 1-2 mm diameter holes that extend into the surface to a depth of 1-2 mm. The stippled upper and lower segments 802 and 804 contain a modified release preparation. Un-numbered middle segment containing perforations 100 comprises inert excipients.

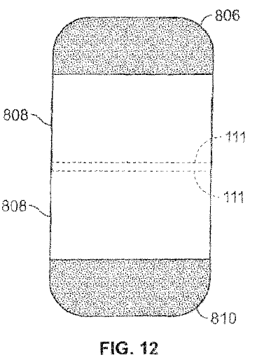

FIG. 12 shows a front view of a confectionery article according to the invention that has two printed dotted lines that serve as a separation mark according to the invention. Middle segment 808 comprises a combination of flavorants or flavor enhancer. Lower segment 810 comprises controlled release beads of a different flavorant or flavor enhancer and upper segment 806 comprises a therapeutic quantity of yet another flavorant or flavor enhancer.

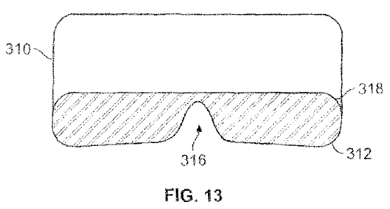

FIG. 13 depicts an immediate release confectionery article with a score 316 that extends approximately 90% through the bottom segment 312. Upper segment 310 allows structural stability of the confectionery article despite the deep score 316. In another preferred embodiment, segment 310 may contain a different flavorant, or the like, than is present in segment 312. In a less preferred embodiment, segment 310 contains a quantity of the flavorant or the like present in segment 312, but in a diminished concentration. Interface 318 is present. In this confectionery article, a flavorant or the like in a composition with altered release characteristics is present in segment 312, and segment 310 lacks a flavorant or the like.

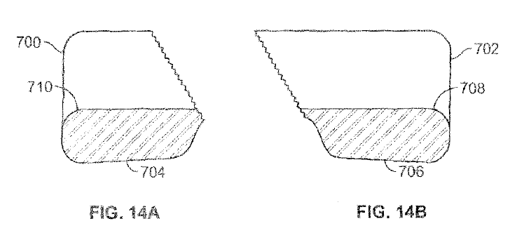

Breaking the confectionery article of FIG. 13 may give two tablettes as shown in FIGS. 14A and 14B, though no limitation as to the direction of confectionery article breaking is intended. Inert segment 310 of FIG. 1 has been divided into two segments, 700 in the smaller tablette as shown in FIG. 2A and 702 in the larger tablette of FIG. 2B. Even though breaking as demonstrated is far from vertical, it is clear that the amount of flavorant or the like in new segments 314 and 315 created from segment 312 of FIG. 1 is similar. Two new segments 706 in FIG. 2B and 704 in FIG. 2A, are created by said creation of the two tablettes. New interfaces 708 and 710 lie at the regions at which segments 702 and 706, and 700 and 704, respectively, adjoin.

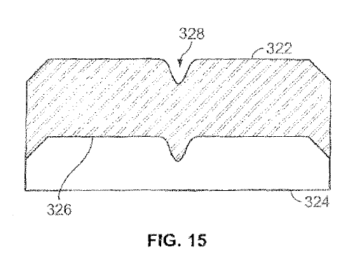

FIG. 15 depicts a two-segment confectionery article. In this confectionery article, lower (bottom) segment 324 contains a flavorant or the like different from that contained in upper (top) part 322. Score 328 indents segment 324. Interface 326 is present at the region at which segments 322 and 324 meet. The confectionery article of FIG. 15 is not a taller than wide confectionery article. FIG. 15 depicts a schematic of a confectionery article of the prior art of bi-layer confectionery articles. One may readily appreciate the difficulty inherent in attempting to break a confectionery article such as the confectionery article of FIG. 15 horizontally, through one segment only, or, analogously, a confectionery article similar to that of FIG. 15 but that in addition was provided with, say, a segment below that of segment 324.

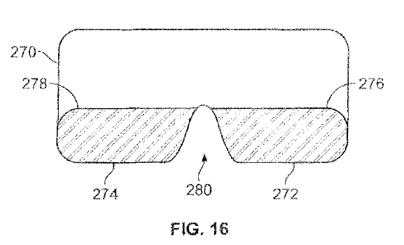

FIG. 16 depicts a confectionery article containing unitary segments 272 and 274 in vertical cross-section, front view. Both of said unitary segments adjoin the same face (surface) of segment 270, which is formed from a single granulation and due to mixing of granulations, contains a flavorant or the like that is present in segments 272 and 274. Interfaces 276 and 278 represent the regions at which segment 270 adjoins segments 272 and 274, respectively. Score 280 indents segment 270 and also represents the space between segments 272 and 274. Unitary segments 272 and 274 contain an altered release composition of a flavoring agent. Segment 270 is formed from inert excipients that do not affect the release rate of said pharmaceutical from the confectionery article.

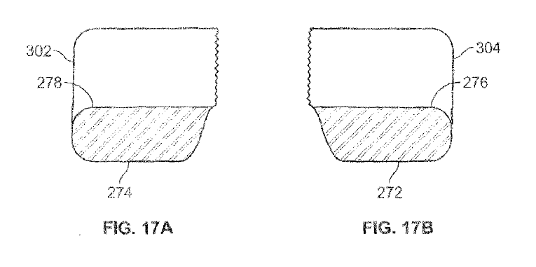

FIGS. 17A and 17B depict the two tablettes created by breaking the confectionery article of FIG. 16 through segment 270. In FIG. 17A, segment 302 represents that part of segment 270 that adjoins intact segment 274. Interface 278 represents the region at which segments 302 and 274 meet. In FIG. 17B, interface 276 represents the region at which segments 304 and 272 meet. Score 280 and segment 270 of FIG. 16 are not considered to exist once the tablettes are formed. Each tablette of FIGS. 17A and 17B contains substantially equivalent mass assuming the score 280 of FIG. 16 is a bisecting score relative to the layer divided, creating segments 272 and 274.

Confectionery articles of the nature of that of FIG. 16 may contain in the unitary segments a mixture of flavorants or, as in FIG. 1, one flavorant. In addition, the granulation that forms segment 270 of FIG. 16 may be provided with a flavorant or the like that is the same as, or different than, that of the divided layer.

In addition, no limitation exists as to the presence of one or more additional segments created superior to (i.e., above) segment 270, or the composition of such. Also, though less likely, there could be another set of different unitary segments inferior to (i.e., below) segments 272 and 274.

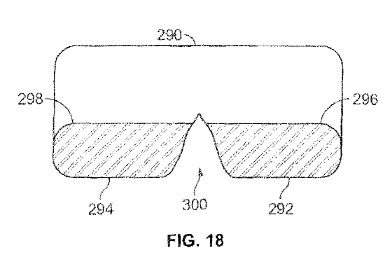

FIG. 18 depicts a confectionery article in a cross-sectional view that is similar to that depicted in FIG. 13, but the confectionery article of FIG. 18 has a score 300 that extends more deeply into the non-unitary segment 290 than does score 280 of FIG. 13. A preferred method of producing score 300 is to use the embossing and manufacturing technique used for the confectionery article of FIG. 13 and then remove, such as with a file, material from segment 290. Alternatively, embossing of the appropriate size and shape may be able to be utilized to create score 300 directly. The confectionery article of FIG. 18 contains unitary segments 292 and 294. Interfaces 296 and 298 are present between segments 292 and 290, and 294 and 290, respectively.

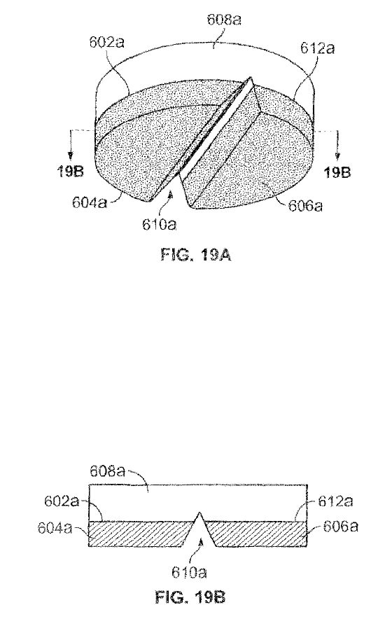

FIG. 19A depicts an external view of a confectionery article containing unitary segments 604a and 606a that are at the bottom of the confectionery article. In this confectionery article, score 610a penetrates into clear, upper, non-unitary segment 608a. Interface 602a represents the region at which segment 608 meets segment 604a. Interface 612a represents the region at which segment 606a meets segment 608a.

FIG. 19B depicts the same confectionery article depicted in FIG. 19A. This vertical cross-section is taken perpendicularly through score 610a, which occupies the diameter of the circular transverse cross-section of the confectionery article. The unitary segments of the confectionery articles of FIGS. 19A and 19B comprises beads producing controlled release of flavorant or the like. Segment 608a contains substantially no flavorant or the like.

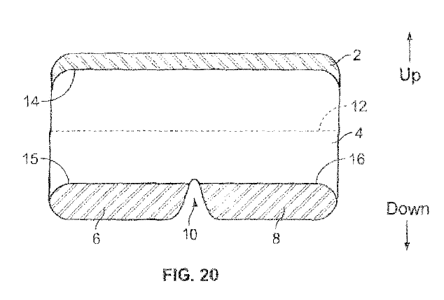

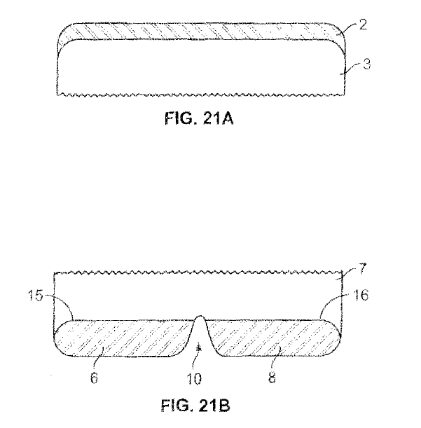

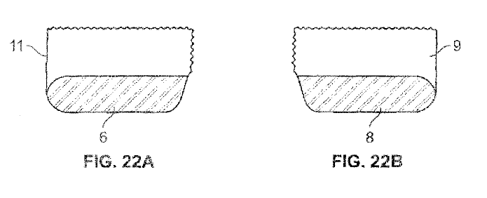

FIG. 20 depicts a confectionery article containing four segments. Unitary segments 6 and 8, as with all unitary segments, are not contiguous with each other. Score 10 penetrates into segment 4. Segment 4 is a compound segment formed from substantially compositionally identical granulations added sequentially with immediate release characteristics. Top segment 2 contains a therapeutic quantity of a flavorant or the like that differs from the flavorant or the like that is present in segments 6 and 8. Dotted line 12 reflects a surface score that runs transversely across segment 4. A preferred horizontal dimension for the confectionery article of FIG. 20 is 12-18 mm, but said dimension is not limited. Interface 14 depicts where segments 2 and 4 are contiguous Interfaces 15 and 16 depict where segments 6 and 8, respectively, adjoin segment 4. Segment 4 contains insignificant quantities of a flavorant or the like found in segments 6 and 2. The confectionery article of FIG. 20 may be broken usefully in two ways One way is vertically through score 10 in the direction of segment 2; such breaking would not utilize the score reflected by dotted line 12, but would give a half portion of the flavorant or the like found in segments 6 and 8, though likely would not give a precise halving of the flavorant found in segment 2, due to difficulties with breaking scored confectionery articles. The result of another way of breaking said confectionery article is depicted schematically in FIGS. 21A and 21B

The relative dimensions of segments in the confectionery article of FIG. 20 are not limited. In said confectionery article, an immediate release formulation is present in the top segment, the middle segment is an inert composition, and the unitary segments comprise a flavorant, flavor enhancer, or the like.

FIG. 21A shows a tablette formed from breaking the confectionery article of FIG. 5 through the horizontal score reflected by dotted line 12. As with other tablettes depicted herein, it is not assumed that breaking is even, but the tablettes are depicted so that breaking is contained substantially within segment 12, that is a segment interposed between upper segment 2 and lower segments 6 and 8 in the confectionery article of FIG. 5. The tablette of FIG. 21A demonstrates that segment 2 is intact, as is interface 14. Segment 3 is formed by the part of segment 4 of the confectionery article of FIG. 5 that remains contiguous with segment 2 The tablette of FIG. 21B depicts segments 6 and 8, and interfaces 15 and 16, as unchanged from the confectionery article of FIG. 5. Segment 7 is the part of segment 4 of FIG. 5 that becomes part of the tablette of FIG. 6B.

A wider than tall confectionery article with a relatively large, breakable middle segment as depicted in FIG. 20 demonstrates that the invention of a confectionery article with a breakable middle segment does not require that the confectionery article be taller than it is wide.

In addition, an external bottom view looking up at the unitary segments of FIG. 20 or FIG. 21B is not shown but if shown could demonstrate that the invention of unitary segments could easily allow for trisecting or quadrisecting

As FIG. 8 demonstrates, cupping or beveling of the upper punch commonly causes the peripheral parts of any segment other than the lowest segment, to extend below the level of the central part of that segment. In order to fully realize the benefit of a “separating segment” per the invention, it is optimal that a transverse plane be able to be placed between the lowest part of a superiorly disposed segment, and the highest part of an inferiorly disposed segment, with said plane passing between an interposed, preferably pharmacologically inactive segment. The vertical distance between the lowest part of a superiorly disposed segment and the highest part of an inferiorly disposed segment is herein denoted the effective height H, which is less than the height (HT) of the middle segment in FIG. 8 due to cupping of the upper punch. Generally, that measurement will be from the vertical height from the bottom of the confectionery article to the plane drawn horizontally from the periphery of the higher segment, due to the cupping or beveling of such a segment, and from the vertical height from the bottom of the confectionery article to the center of the lower segment.

The effective height in the case of beveling or cupping of segments, as easily reflected in the shape of the top of the confectionery article, is always less than the height of the separating or interposed segment through which breaking is intended to occur. The height of an interposed segment is the vertical distance from its highest point to the highest point of the contiguous superiorly disposed segment.

In the case of separating or interposed segments, prior art limits the height to approximately 1 mm for immediate release confectionery articles. The effective height H has been limited to less than that for immediate release confectionery articles.

Another embodiment of the subject invention comprises a bi-layer confectionery article, and preferably comprising unitary segments. Production may involve first allowing a granulation containing a flavorant or the like into a die that has an embossed lower punch, so that said granulation forms an undivided layer indented from below by said embossing. Said embossing is not limited in its pattern. After optional and preferred tamping, an inactive granulation enters the die and after optional pre-compression, a confectionery article is formed by final, full-force compression. This compression pushes the first, lower layer almost to the level of the uppermost aspect of the embossing, so that an especially deep score may be produced. Each granulation, after entry into the die, forms a layer. After final compression of the confectionery article, each layer may also be referred to as a segment of the confectionery article. Except for inadvertent mixing between granulations, the upper segment contains an inert composition, so that confectionery article breaking may occur substantially through the inert segment, thus providing substantial improvement over existing methods of scoring confectionery articles from the standpoint of accuracy of subdividing the article.

Additional preferred embodiments flow from the confectionery article of FIG. 13. In the case in which there were a desire to provide additional flavorant or the like in a segment above the deeply scored segment, a tri-layer design could be useful, given certain practical limitations regarding the height of embossings. In this example, a highly concentrated granulation of a flavorant or the like forms the first granulation, which is pushed as close to the top of the embossing as possible; a second, less concentrated (w/w %) granulation comprising the identical active ingredient enters the die, and a third, inert composition finally enters the die. After final compression, a confectionery article that is preferably very deeply scored with respect to the first segment has been created, and the middle segment, which will tend to break more accurately than the outer segment, improves the accuracy of said confectionery article breaking relative to a confectionery article of simpler design.

Another preferred embodiment related to the example provided by the confectionery article of FIG. 13 is as follows. A first flavorant composition enters the die onto an embossed lower punch and is tamped. A second, inert composition enters the die at the second filling station and again at the third filling station, and is optionally and preferably tamped after each of said granulations enters said die. At a fourth filling station, a different flavorant composition from the first enters the die, is optionally and preferably tamped, and then final compression takes place, pushing said first granulation lower into the die so that the uppermost part of said first granulation remains above the uppermost part of said embossing. Thus, said first granulation has formed an undivided layer. In this example, the use of two identical granulations to form two layers that are compositionally substantially identical may be useful to form one tall segment. Such a segment, whether formed from two or more substantially identical granulations or ones comprising a flavorant or the like, is called a compound segment herein.

The utility of the article is that it allows different flavorant or the like to primarily be placed in opposite ends of a “taller than wide” confectionery article, so that both flavorants may be given together in a whole confectionery article, but said confectionery article also may be broken through a middle segment to create two tablettes comprising substantially different flavorants (ignoring any inadvertent mixing between granulations). The current invention is most usefully employed after such optional confectionery article breaking through said middle segment, after which the first segment may then be itself subdivided if desired to create a plurality of accurately dosed tablettes.

The above example could as easily utilize a granulation compositionally substantially identical to said first granulation to enter (again) at the fourth filling station. Further segments could be added as a fifth segment and beyond, technical capacity for confectionery article production being the limiting factor. Furthermore, said second segment could comprise a flavorant or the like, or a mixture of flavorants present in both the first and third segments in the example above, and the utility of the invention would persist.

The invention thus teaches novel methods of manufacture of deep scores within pharmacologically active parts of the confectionery article containing flavorants/colorants, or the like. Preferred methods of manufacture of the confectionery articles of the invention that utilize an embossed bottom punch to produce the scored segment that is the subject of the invention utilize an upper punch that does not have any embossing, or else has an embossing of a small vertical dimension, above the embossing present on and extending upwards from the base of said lower punch.

A different mode of manufacture may be employed, using an embossed upper punch and a preferably flat-faced lower punch. In this technique, a most preferred confectionery article of the invention may be produced as follows. A first, inert granulation enters the die and is optionally tamped. A second granulation, comprising a flavorant or the like, then enters the die, is optionally tamped, and final compression occurs. Some amount of the flavorant or the like lies under the lower part of said embossing but the bulk of second granulation is apart from the breaking area, and thus when and if force is applied in a conventional, vertical fashion to the lowest aspect of the score, highly accurate confectionery article breaking will take place with respect to the flavorant or the like.

In addition, similar means of marking confectionery articles may be followed such as by causing an edible ink to be placed on the confectionery articles, thus delineating a desired breaking region of the confectionery article, such as its middle segment. Such application is well known in the art. Other means of applying indicia are contemplated as within the scope of the invention.

Preferred confectionery articles of the invention often use a height and an effective height H that are both over 4 mm, and may exceed 6 mm. Lesser heights and effective heights are utilized when needed due to size constraints on the confectionery article.

In the present invention, any known hard candy composition may be used. Suitable hard candy compositions can be made from varying, but highly concentrated, sucrose solutions including corn syrup as a second essential ingredient. One suitable formulation, for example, includes from about 55% to about 90% by weight of sucrose solids and from about 10% to about 45% by weight of corn syrup solids dissolved in a small amount of water.

Other known hard candy compositions may utilize any suitable good testing, sweet excipient other than sucrose. These compositions may also be used in the present invention. These other sweet excipients include dextrose and the sugar alcohols, mannitol and sorbitol. Sugar alcohols are particularly preferred for use herein because they provide lozenges which are “sugarless” and can provide a cool mouth-feel for the article.

When the sweet excipient is an sugar alcohol, it may be necessary to add an artificial sweetener to provide an article with an acceptable taste. While sorbitol is preferred, it may be substituted by or used in combination with other sugar alcohols.

The amount of sweet excipient is selected to give the article a pleasantly sweet taste. For the purpose, the sweet excipient makes up 25 to 60% by weight, preferably from 35 to 50%.

In addition, confectionery article compositions can have a diverse makeup and can differ in regard to their physical and/or chemical properties. For example, the compositions can be nougats or chewing gum compositions. As used herein “physical and/or chemical properties” is intended to mean any one or a combination of coloration, ingredient composition or texture characteristics. Thus, it could be that two separate composition sources could have the same general hard candy ingredients but they would differ as to the flavoring or as to the colorants used in each. On the other hand the two compositions might have entirely different confection makeup in that one might be a hard candy composition, whereas the other would be a chewy composition, e.g., a nougat composition of the kind disclosed in B. W. Minifie, CHOCOLATE, COCOA AND CONFECTIONERY: Science and Technology, 2nd Edition, AVI Publishing Co., Inc., Westport, Conn., (1980), at pp. 424-425.

A chewy confection could for example be of the nougat compositions disclosed in the above-mentioned Minifie reference, being made of soft confectionery materials. These materials contain two primary components, namely, a high boiling syrup such as corn syrup or the like, and a relatively light textured frappe, generally prepared from gelatin, egg albumen, milk proteins such as casein, and vegetable proteins such as soy protein, and the like. The frappe is generally relatively light, and may, for example, range in density from about 0.5 to about 0.7 g/cc. By comparison, the high boiling syrup, or “bob syrup,” is relatively viscous and possesses a higher density, and frequently contains a substantial amount of sugar. Conventionally, the final nougat composition is prepared by the addition of the “bob syrup” to the frappe under agitation, to form the basic nougat mixture. Further ingredients such as flavorings, oils, additional sugar and the like may be added thereafter also under agitation.

With respect to chewing gum formulations, such will contain a gum base and various additives, such as sweeteners and flavors. The gum base employed will vary greatly depending on various factors such as the type of base used, consistency desired and other components used to make the final product. The chewing gum composition may additionally include the conventional additives of flavoring agents, coloring agents, emulsifiers and additional fillers.

Alternatively, gum-containing articles of the invention may be provided as gummy candy. Gummy candy represents a more recent advance in candy technology, and is derived from pectin and starch formulations first developed in Germany in the early I900s by Hans Riegel. The ingredient responsible for the unique, gummy characteristics of gummy candy is gelatin. Various sugars can be added as sweeteners, such as sucrose, fructose, corn syrup, sorbitol, or the like.

Artificial and natural flavors can also be used to create a unique taste for the gummy candy embodiment of the subject invention. These flavorants are well known in the art and can include natural flavors, which can be obtained from fruits, berries, honey, molasses, maple sugar, or the like, or can include artificial flavors, which are mixtures of aromatic chemicals such as methyl anthranilate and ethyl caproate, or acids such as citric acid, lactic acid, and malic acid.

Because gelatin has a natural faint yellow color, dyes are added to create the wide array of colors found in gummy candy. Typical dyes include Red dye #40, Yellow dye #5, Yellow dye #6, and Blue dye #1. Using these federally regulated dyes, gummy manufacturers can make the candy almost any color they desire.

The textural characteristics of gelatin gels depend on many factors, such as temperature, method of manufacture, and pH. While the manufacturing method and temperature can be physically controlled, the pH is controlled chemically by the addition of acids. These include food grade acids such as citric acid, lactic acid, fumaric acid, and malic acid. In addition to the above-mentioned ingredients, other ingredients can be added during the manufacturing process such as lubricants or shine-enhancing agents. These shine-enhancing agents can include beeswax, coconut oil, carnauba wax, mineral oil, partially hydrogenated soybean oil, pear concentrate, and confectioner's glaze, or the like as are well known in the art.

The manufacture of gummy candy is known to employ a starch molding process. For example, the candy formulation is first made as a liquid, then it is filled into starched lined trays. The filled trays are then cooled overnight and the resulting formed candy is emptied from the trays. In the mass production of gummy candy, significant improvements have been made to increase the speed and efficiency of this process.

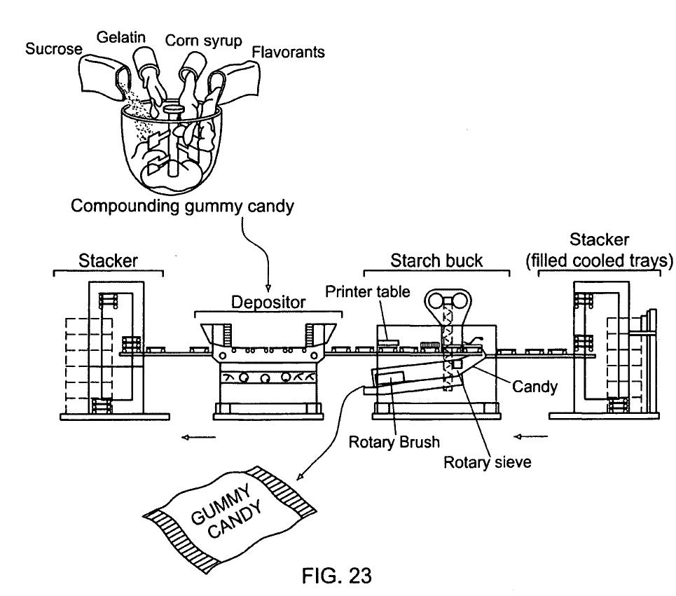

The manufacture of gummy candy can be a continuous, automated process. This process is illustrated in FIG. 23. As illustrated, gummy candy is manufactured in a machine called a Mogul, and does not require the use of a tablet press.

The variations that one may practice with regard to these confections are wide ranging and within the ability of those skilled in the art particularly with regard to use of additional composition fillers, texture modifiers, flavoring components, use of coloring agents and the particularized involvements required for admixing or embodying medicinal, medicament and nutrient substances in effective manners in selected or given ones of confection compositions.

The flavor composition generally comprises from about 20% to about 99.5%, preferably from about 30% to about 99%, and more preferably from about 40% to about 95% of the total confectionery product. An essential component of the flavor composition is a flavoring agent or flavorant.

As used herein, the term ‘flavoring agent’ means those flavor essences and equivalent synthetic ingredients which are added to the flavor composition for the principal purpose of providing flavor to the confectionery product. Flavoring agents well known in the confectionery art can be added to the flavor compositions of the invention. These flavoring agents can be chosen from synthetic flavoring liquid and/or oils derived from plants leaves, flowers, fruits and so forth, and combinations thereof. Representative flavoring liquids include: cinnamon oil, artificial, natural or synthetic fruit flavors such as citrus oil including lemon, orange, banana, grape, lime, apricot and grapefruit and fruit essences including apple, strawberry, cherry, orange, pineapple and so forth, bean and nut derived flavors such as coffee, cocoa, cola, peanut, almond and so forth. Preferred flavoring agents are chosen from natural or synthetic fruit flavors such as citrus oil including lemon, orange, lime, and grapefruit and fruit essences including apple, strawberry, cherry, orange, pineapple and so forth.

The amount of flavoring agent employed is normally a matter of preference subject to such factors as flavor type, base type and strength desired. In general, amounts up to about 4% by weight and preferably from about 0.1% to about 3.0% by weight of the flavor composition are usable with amounts of about 0.4% to about 1.5% being preferred. Alternatively, or additionally, the article of the subject invention can include the use of cooling agents. Cooling agents include carboxamides, menthol, eucalyptus, menthane esters and menthane ethers.

It is recognized that related embodiments may be within the spirit of this disclosure. Also, no omission in the current application is intended to limit the invention to the current claims or disclosure. While certain preferred and alternative embodiments of the invention have been set forth for purposes of disclosing the invention, modifications to the disclosed embodiments may occur to those who are skilled in the art.

1. A confectionery article of manufacture comprising:
(a) a first confectionery composition forming a bottom layer as the article is oriented during manufacture, said first composition comprising a confectionery ingredient or a mixture of confectionery ingredients, said composition being free of active pharmaceutical ingredient;
(b) a second confectionery composition forming a top layer as the article is oriented during manufacture, said composition comprising a confectionery ingredient or a mixture of confectionery ingredients, said second composition being free of active pharmaceutical ingredient; and
(c) said first and second confectionary compositions forming a bi-layer confectionery article having at least one deep score in the top or bottom layer.

2. The confectionery article of manufacture of claim 1 wherein the article is compressed in a compression die using top and bottom punches, wherein at least one of said top or bottom punches comprises an embossing of sufficient height to form a deep score in the respective top or bottom layer.

3. The confectionery article of claim 1 wherein the article is formed in a mold.

4. The confectionery article of claim 1 wherein at least one of said compositions comprises a flavoring ingredient.

5. The confectionery article of claim 1 wherein at least one of said compositions comprises a flavoring enhancer.

6. The confectionery article of claim 1 wherein at least one of said compositions is formulated as a rapidly dissolving composition.

7. The confectionery article of claim 1 wherein at least one of said compositions is formulated as a slowly dissolving composition.

8. The confectionery article of claim 4 wherein the slowly dissolving composition provides extended-release characteristics to the flavoring ingredient contained in the composition.

9. The confectionery article of claim 1 wherein at least one of said compositions is a candy formulation.

10. The confectionery article of claim 1 wherein at least one of said compositions is a chewing gum or bubble gum formulation.

11. The confectionery article of claim 1 wherein one of said compositions is a candy formulation and one of said compositions is a chewing or bubble gum formulation

12. A confectionery article of manufacture said article comprising three or more layers forming three or more segments and configured to have its height greater than its width as oriented during its manufacture, said article comprising:
(a) a first layer comprising a first confectionery composition forming an end segment, as oriented during manufacture, said first composition comprising a confectionery ingredient or a mixture of confectionery ingredients and being free of active pharmaceutical ingredient;
(b) a second layer comprising a second confectionery composition forming a middle segment, as oriented during manufacture, said composition comprising a confectionery ingredient or a mixture of confectionery ingredients different than said first composition and being free of active pharmaceutical ingredient; and
(c) a third layer forming an end segment, said third layer comprising said first confectionery composition, or a third confectionery composition comprising a confectionery ingredient or mixture of confectionery ingredients different than said first or second compositions, said third composition being free of active pharmaceutical ingredient.

13. The confectionery article of manufacture of claim 12 wherein the article is compressed in a compression die using a multi-layer tablet press.

14. The confectionery article of claim 12 wherein the article is formed in a mold.

15. The confectionery article of claim 12 wherein at least one of said compositions comprises a flavoring ingredient.

16. The confectionery article of claim 12 wherein at least one of said compositions comprises a flavoring enhancer.

17. The confectionery article of claim 12 wherein at least one of said compositions is formulated as a rapidly dissolving composition.

18. The confectionery article of claim 12 wherein at least one of said compositions is formulated as a slowly dissolving composition.

19. The confectionery article of claim 15 wherein the slowly dissolving composition provides extended-release characteristics to the flavoring ingredient contained in the composition.

20. The confectionery article of claim 12 wherein at least one of said compositions is a candy formulation.

21. The confectionery article of claim 12 wherein at least one of said compositions is a chewing gum or bubble gum formulation.

22. The confectionery article of claim 12 wherein at least one of said compositions is a candy formulation and at least one of said compositions is a chewing gum or bubble gum formulation.

23. A method for manufacturing a compressed bi-layered and deep-scored confectionery article, said method comprising:
(a) providing a compression die having a top and bottom punch for use with a bi-layer tablet press, wherein at least one of said top or bottom punches comprises one or more embossing for forming one or more deep scores in the respective top or bottom layer of the confectionery article when compressed;
(b) providing a first confectionery composition comprising a confectionery ingredient or a mixture of confectionery ingredients and being free of active pharmaceutical ingredient;
(c) providing a second confectionery composition comprising a confectionery ingredient or a mixture of confectionery ingredients and being free of active pharmaceutical ingredient,
(d) dispensing said first confectionery composition into the compression die to form a first layer;
(e) optionally, tamping said first layer;
(f) dispensing said second confectionery composition into the compression die and onto said first layer, thereby forming a second layer;
(g) optionally tamping said second layer; and
(h) compressing said first and second layers to form the bi-layer confectionery article having at least one deep score.

24. The method of claim 23 wherein the bottom punch comprises an embossing having a height such that said embossing extends completely through the bottom layer and thereby forms the bottom layer into unitary segments.

25. The method of claim 23 wherein the top punch comprises an embossing which extends a distance substantially equal to or greater than the thickness or height of said top layer of the confectionery article, thereby forming a deep score in said top layer.

26. A method for manufacturing a confectionery article, said article comprising three or more layers forming three or more segments and configured to have its height greater than its width as oriented in a compression die, wherein at least one of said segments comprises a confectionery composition which is different from the confectionery compositions forming the other segments, said method comprising the steps of:
(a) providing a compression die having a top and bottom tablet punch for use with a tablet press capable of forming a compressed article having three or more layers;
(b) providing a first confectionery composition comprising a confectionery ingredient or mixture of confectionery ingredients and being free of active pharmaceutical ingredient;
(c) providing a second confectionery composition comprising a confectionery ingredient or mixture of confectionery ingredients and being free of active pharmaceutical ingredient;
(d) optionally, providing a third confectionery composition comprising a confectionery ingredient or mixture of confectionery ingredients and being free of active pharmaceutical ingredient;
(e) dispensing into the compression die the first composition to form a first layer;
(f) optionally, tamping said first layer;
(g) dispensing into the compression die and onto the first layer said second composition, thereby forming a second layer;
(h) optionally tamping said second layer;
(i) dispensing into the tablet die and onto the second layer said first or third confectionery composition, thereby forming a third layer;
(j) optionally, tamping said third layer; and
(k) compressing said first, second and third layers to form the layered article.

27. The method of claim 27 wherein said method further comprises forming a fourth layer comprising a confectionery composition different than the composition forming the third layer.

28. The method of claim 27 wherein said method further comprises forming five or more layers.

29. A confectionery article formed by the method of claim 23.

30. A confectionery article formed by the method of claim 27.
